(19) United States
(12) Patent Application Publication
(10) Pub. No.: US 2021/0015591 A1
(43) Pub. Date: Jan. 21, 2021

(54) METHOD OF FABRICATING A DENTURE

(71) Applicant: CMP INDUSTRIES LLC, Albany, NY (US)

(72) Inventor: Devon O. HOWE, Malta, NY (US)

(21) Appl. No.: 16/512,837

(22) Filed: Jul. 16, 2019

(51) Int. Cl. A61C 13/01; A61C 13/20; A61C 13/10; A61C 9/00; A61C 13/00; B33Y 50/02; B33Y 80/00; B29C 33/38; B29C 64/393; B29C 43/18

(52) U.S. Cl. CPC A61C 13/04; A61C 13/20; A61C 13/1003; A61C 9/0046; A61C 13/0004; B33Y 10/00; B33Y 50/02; B33Y 80/00; B29C 33/3842; B29C 64/393; B29C 43/18; A61C 13/0019

(57) ABSTRACT

A method of making a denture comprised of fabricating a mold form, including a mold surface corresponding to an external surface of the denture; casting a liquid mold block material against the mold surface of the mold form, and curing the liquid mold block material to form a solid mold block including a second mold surface corresponding to the external surface of the denture. Denture teeth are placed in the tooth sockets of the mold block. Denture base material is delivered against the denture base surface portion of the second mold surface and bases of the denture teeth. The liquid denture base material is cured into a solid state to form a denture base block including embedded denture teeth. The denture base block is placed in a milling fixture; and milled to form the internal surface of the denture.

### BACKGROUND

### Technical Field

Design and manufacturing of dental prostheses.

### Description of Related Art

The manufacture of dental prosthetics by computer aided design (CAD) and computer aided manufacturing (CAM) has advanced significantly in recent years, with respect to both removable dental prosthetics, and fixed dental prosthetics.

Removable dental prosthetics may be provided as complete dentures, or partial denture frameworks. Around 2007, a commercial CAD/CAM system for the fabrication of partial denture frameworks was introduced to the dental prosthesis market. This was the first CAD/CAM system for “removable” dentistry. The system uses a “haptic” device which mimics a waxing tool that is familiar to dental technicians. However, the system only generates a CAD replica in plastic that required extensive processing to obtain a metal partial denture framework. There are still many error-prone steps after the CAD replica is made, which may result in a poorly-fitting partial denture framework.

Presently, there are many software systems available for designing a digital partial denture framework. From a digitally-designed framework, a three dimensional (3D) printed model of the framework may be made on a commercially available 3D printer. A dental laboratory will invest the framework model with dental investment in a “ring” and then place the ring into a burnout furnace. The furnace will heat the ring until the framework model is vaporized. Then the very hot ring will be placed into a casting machine and then alloy will be heated by the machine and injected into the void that was created from the framework model. While the process to develop the framework is new, this overall process has long been known and is called “the lost wax technique.”

There have also been many approaches to make complete (full) dentures using CAD/CAM technologies. A few of the major methods are subtractive manufacturing, additive manufacturing, and hybrids of the two.

Subtractive manufacturing of a complete denture is performed by milling a denture base and denture teeth from solid bodies of denture base and denture teeth material, i.e., denture base and denture teeth material are subtracted by milling or otherwise carving it away from starting blocks, thus leaving the desired denture base and denture teeth in place to form the denture.

In one exemplary method for making a two-piece digital denture, a first piece is formed as the denture base, which is milled from a pre-fabricated block of pink-colored polymethyl methacrylate (PMMA) acrylic material. The PMMA starting material is molded as a block under high pressure so that it is very dense. The denture base is milled to the shape of the denture with sockets to receive the second piece, milled denture teeth. The second piece of formed denture teeth is made via milling, much the same way as the first piece of the formed denture base. The starting material for the second piece may be a whitish-colored PMMA acrylic material formed under high pressure. The second piece may be made in very subtle layers so that the incisal (biting) edge of the teeth will look translucent to most closely simulate the esthetics of natural teeth. The denture teeth piece is then cemented or bonded into place in the sockets formed in the denture base piece. Auto-polymerizing resins may also be used to mate the two pieces together.

The shortcomings of this approach are at least two-fold:
The denture teeth may not look as natural as conventional denture teeth because conventional denture teeth are made to have a variation of color that originate in darker from the central neck of the tooth and radiate outward so that the sides of the teeth are slightly lighter in color. This is not possible with a layered manufacturing method for making a milling block.
The bonding of the teeth to the base can result in gaps between the materials that are more prone to bacterial growth. This can result in black lines around the juncture of the denture teeth and the pink denture base. (This effect is well-known by dentists who are familiar with using porcelain denture teeth because synthetic porcelain teeth do not have a chemical bond to the denture base. Thus, quite often bacteria can grow in the interface.)

In another method of making a complete denture that is “fully milled,” a denture base disc is first milled, including sockets for receiving denture teeth. The sockets are filled with fluid polymethylmethacrylate (PMMA) denture tooth material, which is then polymerized with heat and pressure. The denture tooth material is milled again to remove unneeded tooth material and form the teeth in final form, yielding a completed denture.

The shortcoming of this denture fabrication process is that it is relatively expensive due to the extensive milling time required. In addition, the esthetics of the teeth are good, but not as good as teeth made by conventional compression-molding methods. This is because the precision of milling is not as detailed as molds manufactured for denture teeth fabrication. In addition, highly esthetic denture teeth are molded in three, four and five layers, whereas the above process is limited to molding in layers due to the milling time required.

As stated above, complete dentures may be fabricated by additive manufacturing methods, commonly referred to as 3D printing. In one commercial system, both the denture teeth and denture base are printed separately using a small digital light processing (DLP) 3D printer. Then the teeth are bonded to the base using base print resin and then curing them together in a light-cure unit. There are numerous problem with this and similar systems. Firstly, the teeth are mono-chromatic and un-esthetic. There is little to no translucency at the incisal edge as would be expected to mimic natural teeth. Additionally, the material is not as strong as conventional denture materials, so the teeth and/or base may break. The teeth must be printed together because the material is not strong enough to make individual teeth. As a result, there is no true interproximal space between the teeth and this appears un-natural. Lastly, the tooth-material is prone to pre-mature wear as compared to conventionally-produced denture teeth which are made under high pressure and temperature which fully polymerizes the material. Printed tooth-material is not as densely cross-linked as compared to conventional denture teeth.

Some commercial development has occurred in the field of hybrid denture fabrication systems. Printing denture base and using pre-manufactured teeth is a method being promoted by several manufacturers of 3D printers and software developers. In general, the technique is to design the denture digitally, then print only the denture base. Then pre-manufactured denture teeth are placed into the “sockets” created by the 3D printed denture base. This is a relatively cheap method to make “digital dentures.” However, there are some serious shortcomings with this method as well.

Occlusion (matching of upper teeth arch to lower teeth arch) is poor. The most laborious and highly skilled process of making a denture is setting the teeth into proper occlusion. A benefit of CAD/CAM workflow is to reduce this time and cost by using the CAD software to set the occlusion. However, in the hybrid process above, the vertical dimension between upper and lower ridge in the patient's mouth may not be enough to accommodate pre-manufactured teeth without first adjusting (grinding) them to reduce height. If this process is performed manually, then the benefit of CAM occlusion is lost because the teeth will have to be re-occluded manually. One way around this problem can be to prepare a “reduction coping.” With this method, a separate guide can be designed and 3D printed in which the pre-manufactured denture teeth are placed into, then the height of the teeth can be manually adjusted using the guide to determine how much height to adjust. While this is an improvement over adjusting teeth without a guide, it still leaves imperfect occlusion.

Additionally, the teeth must be bonded to the 3D printed denture base using uncured denture base resin or other bonding agent. This is a potential problem because the 3D printed denture base resin does not fully bond to the denture teeth in the same way that conventional denture bases bond to denture teeth. (Conventional denture bases contain uncured methylmethacrylate monomers, which attack the surface of the pre-manufactured denture teeth and “soften” the surface so that the denture base polymer can chemically inter-link with the denture teeth.)

Removable dental prosthetics that are of high precision, low cost, and improved esthetics are needed. Accordingly, improved manufacturing processes that enable meeting these goals are also needed.

### SUMMARY

The dental prosthetic fabrication methods of the present disclosure meet these needs. In one aspect of the methods, CAD/CAM is used to make a replica (pattern) denture and a flange with which to prepare a mold. The mold is used so that pre-manufactured denture teeth can be placed in perfect occlusion and conventional denture bases can be used to form a pink disc with teeth chemically bonded to the base. The denture base disc is then milled to form the tissue side of the denture.

More specifically, in accordance with the present disclosure, a method of making a denture is provided. The denture is comprised of a denture base and denture teeth, and has an external surface (which touches the labia and tongue) and an internal surface which has intimate contact with the edentulous ridge of the patient. The method is comprised of fabricating a mold form, including a first mold surface corresponding to the external surface of the denture; casting a liquid mold block material against the first mold surface of the mold form, and curing the liquid mold block material into a solid or semi-solid state to form a mold block including a second mold surface corresponding to the external surface of the denture. The second mold surface includes denture tooth sockets contiguous with a denture base surface portion. The method further comprises placing denture teeth in the tooth sockets of the mold block; delivering liquid denture base material against the denture base surface portion of the second mold surface and against bases of the denture teeth, and curing the liquid denture base material into a solid state to form a denture base block including embedded denture teeth that fits an existing milling fixture; and milling the denture base block to form the internal surface of the denture.

The method may further comprise creating a three dimensional digital CAD model of the denture, which includes data defining the external surface of the denture usable to define the first mold surface of the mold form. An impression of the dentition of a patient who will use the denture may be obtained. The impression may be used to define the three dimensional digital CAD model of the denture. In certain embodiments, the mold form may be made by milling mold form material from a mold form material starting block. The milling may be performed by operating a CNC mill based on data of the 3D CAD model of the denture. In alternative embodiments, the mold form is made by 3D printing. The 3D printing may be performed by a CNC mill based on data of the 3D CAD model of the denture. The 3D printing may be performed by operating a 3D printer based on data of the 3D CAD model of the denture.

In certain embodiments, the mold form may be bounded by a cylindrical perimeter and the mold form may be placed in a cylindrical mold fixture prior to casting the liquid mold block material. The mold form may include an annular flange surrounding the first mold surface. After forming the mold block, the mold block may be removed from a mold fixture, inverted, and replaced in the mold fixture. The denture teeth may then be placed in the tooth sockets of the mold block. In certain embodiments, milling the denture base block may include removing upper portions of the embedded denture teeth. The method may be further comprised of removing support material from the denture base following the milling the denture base block.

The method, and a denture made by the method, have numerous advantages over conventional denture fabrication methods. The method is faster in producing a denture because only one side of the denture must be done by milling, which is the most time consuming step in the denture fabrication process. In other CAD/CAM based denture fabrication processes, the entire denture must be formed by milling, including the external side or surface that is exposed in the mouth, and the internal surface or side that is held against the mouth tissue. This prolonged use of milling increases denture fabrication cycle time, thus lowering throughput and increasing cost. The method is also lower with respect to capital equipment costs. The equipment that is required is already in place in most dental labs, including a scanner, 3D printer, and denture base and tooth material liquid delivery systems, vessels, and fixtures. The purchase of significant new capital equipment is not required to practice the method.

With regard to materials, certain intermediate fabrication steps can be practiced with conventional colloid materials. More importantly, the method can be practiced using conventional denture base material and conventional denture teeth. These materials are known to be biocompatible, and known to have a strong bond between the denture base and denture teeth. A denture made according to the method has excellent esthetics, fit, and occlusion. Because the system is fully digital, and requires no “guesswork”—such as manually grinding pre-manufactured denture teeth—a denture made according to the method will fit the patient well, and the teeth will be set in precise digital occlusion.

### BRIEF DESCRIPTION OF THE DRAWINGS

The present disclosure will be provided with reference to the following drawings, in which like numerals refer to like elements, and in which:

FIG. 1 is a side cross-sectional view of a mold form including a first mold surface corresponding to the external surface of the denture, the mold form contained in a molding fixture;

FIG. 2 is a top view of the mold form contained in the molding fixture of FIG. 1;

FIG. 3 is a side cross-sectional view of the mold form and molding fixture of FIG. 1, depicting the step of fabricating a mold block of colloid material within the molding fixture;

FIG. 4 is a side cross-sectional view of the molding fixture as shown in FIG. 3, but with the mold fixture inverted, and with the mold form of FIG. 1 removed;

FIG. 5 is a side cross-sectional view of the molding fixture as shown in FIG. 4, with denture teeth placed in tooth sockets and fixture covers positioned to form a denture base mold cavity;

FIG. 6 is a side cross-sectional view of the molding fixture as shown in FIG. 5, following the delivery of denture base material into the denture base mold cavity;

FIG. 7 is a side cross-sectional view of a denture base block with embedded denture teeth removed from molding fixture at the start of milling of the denture base;

FIG. 8 is a side cross-sectional view of a nearly completed denture, at a point near completion of the milling of the denture base; and

FIG. 9 is a side cross-sectional view of a completed denture; and

FIG. 10 is a flow chart of a method of making a denture in accordance with the present disclosure.

The present invention will be described in connection with certain preferred embodiments. However, it is to be understood that there is no intent to limit the invention to the embodiments described. On the contrary, the intent is to cover all alternatives, modifications, and equivalents as may be included within the spirit and scope of the invention as defined by the appended claims.

### DETAILED DESCRIPTION

For a general understanding of the present invention, reference is made to the drawings. In the drawings, like reference numerals have been used throughout to designate identical elements. The drawings are to be considered exemplary, and are for purposes of illustration only. The dimensions, positions, order and relative sizes reflected in the drawings attached hereto may vary.

In the following disclosure, certain components may be identified with the adjectives “top,” “upper,” “bottom,” “lower,” “left,” “right,” etc. These adjectives are provided in the context of the orientation of the drawings. The description is not to be construed as limiting the methods of the present disclosure to use in a particular spatial orientation. The methods and related apparatus may be used in orientations other than those shown and described herein.

It is also to be understood that any connection references used herein (e.g., attached, coupled, connected, and joined) are to be construed broadly and may include intermediate members between a collection of elements and relative movement between elements unless otherwise indicated. As such, connection references do not necessarily imply that two elements are directly connected and in fixed relation to each other.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the inventive scope of the present disclosure.

The term “providing”, such as for “providing a molding fixture” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The term “semi-solid material” as used herein is meant to indicate a material that behaves as a solid, i.e., no deformation of the material occurs, until a threshold stress is applied. At or above the threshold stress, the material deforms irreversibly, i.e., the material flows or creeps. When the stress at or above the threshold is removed, the semi-solid material reverts to a non-flowing solid state.

A method of making a denture in accordance with the present disclosure will now be described. It is to be understood that the denture in the following disclosure is an exemplary “complete” denture comprised of mandibular teeth. It is to be understood that the method described herein is not limited to mandibular dentures. The method is also applicable to maxillary dentures and partial dentures.

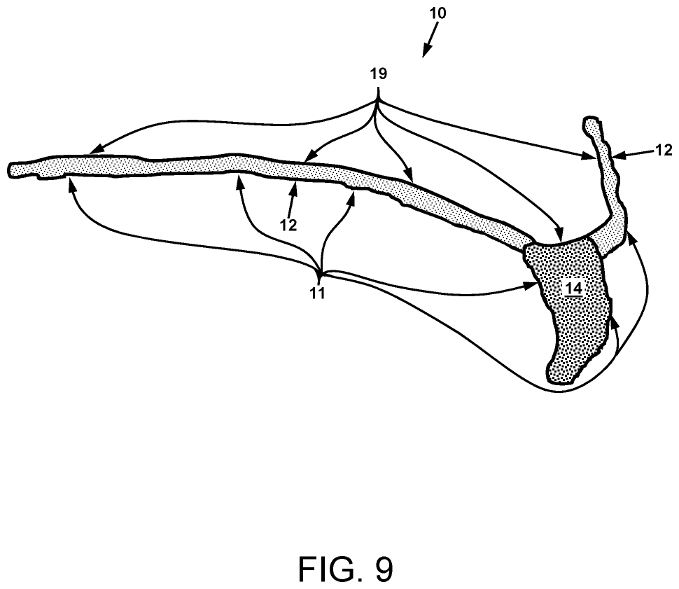

Referring first to FIG. 9, an exemplary complete denture 10 is comprised of a denture base 12 and denture teeth 14. The denture 10 has an exposed external (lingual and labial) surface 11, which includes the surfaces of teeth 14 and exposed surfaces of the denture base 12, which are contacted by saliva and food during chewing, and which may be visible within the mouth. The denture 10 has an internal surface 19, which, when in use, is contacted with and adhered to the tissue of the patient's mouth (not shown).

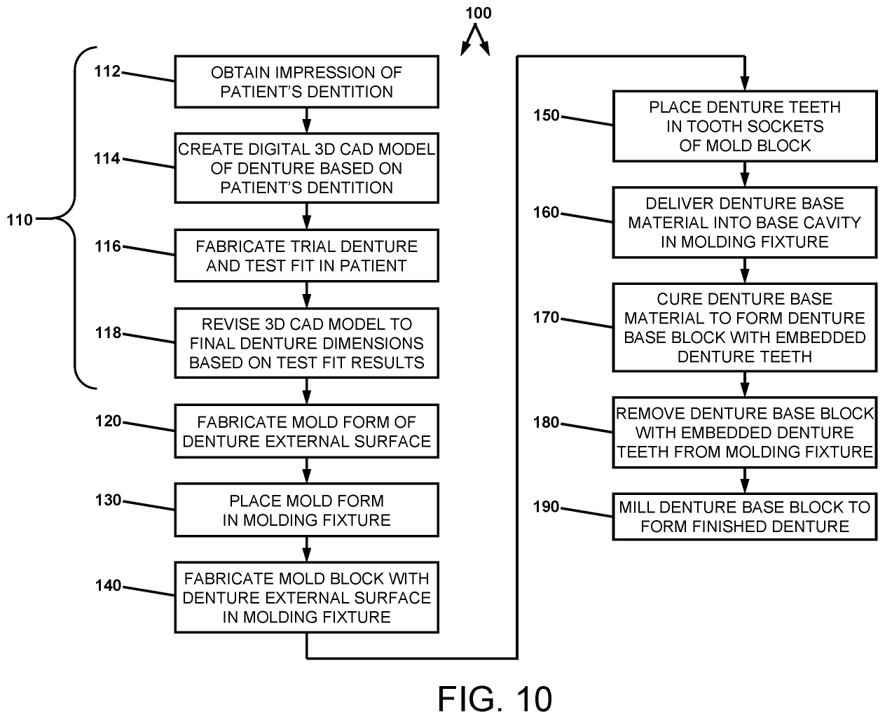

Referring to FIG. 10, in the method 100 shown therein, certain preparatory/denture design steps 110 are performed prior to fabrication of a mold form in step 120 that includes a denture external surface. In step 112, an impression of the patient's dentition is obtained. The impression (or model of the impression) and occlusal registration of the complete denture (and opposing arch, if any) may then be digitally scanned. From this data, a digital 3D CAD model of denture may be created in step 114. In step 116, a replica of the finished denture is fabricated by additive (e.g., 3D printed using a plastic) or subtractive (e.g., milling) methods, and a trial fit in the patient is performed. The dentist checks for proper occlusion, speech, lip support, smile line, tooth position and general esthetics. The dentist will note changes, if any, and return the replica denture to the denture fabrication laboratory. If changes are requested, the lab will revise the 3D model in step 118 and fabricate a new denture for a second trail fit in the patient.

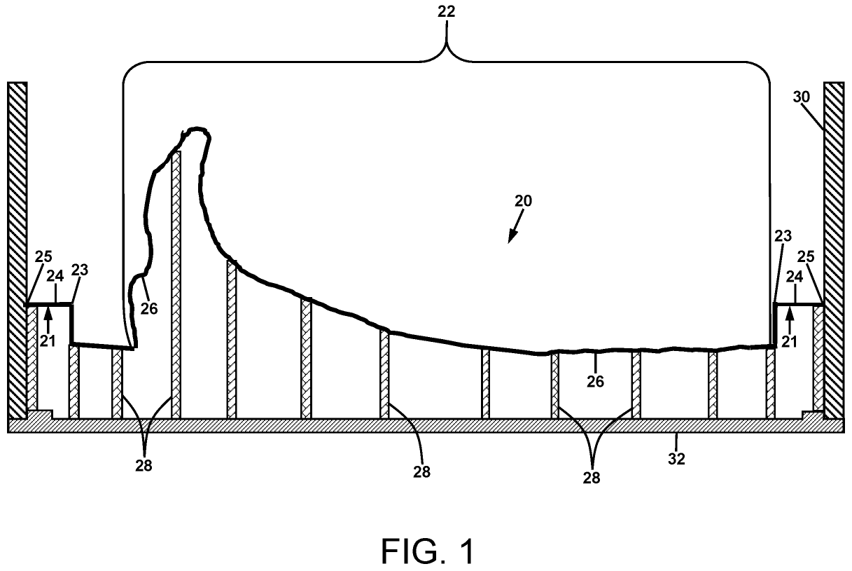

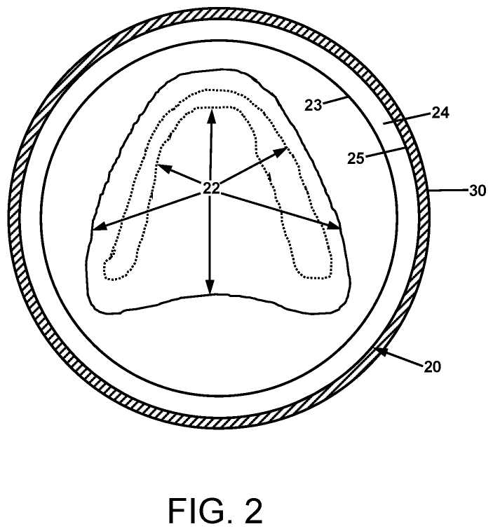

Once the desired final dimensions of the denture are determined, a mold form is fabricated in step 120. Referring to FIGS. 1 and 2, the mold form 20 includes a region 22 corresponding to the external surface of the denture. The mold form 20 is further comprised of an annular flange 21 having a horizontal flange surface 24 bounded by an inner edge 23 and an outer edge 25. The mold form 20 may be fabricated by a suitable 3D additive or subtractive method. In one embodiment (not shown), the mold form 20 may be fabricated as a solid block. In the embodiment shown in FIG. 1, the mold form 20 is fabricated with the external surface of the denture and the annular flange formed as a shell 26, and with supports 28 joined to the shell 26. When fabrication of the mold form 20 is complete, it is placed in a cylindrical mold flask or fixture 30 with the supports 28 disposed on a solid cover 32 that is fitted to the fixture 30. The outer edge 25 of the flange 21 is substantially equal in diameter to the inside diameter of a cylindrical fixture 30 so as to enable a sliding fit therein. Referring also to FIG. 10, the mold form 20 is placed in the mold fixture 30 in step 130. In certain embodiments, the mold fixture 30 may be about 98 millimeters (mm) in diameter, and the height of the flange 21 may be about 20 mm.

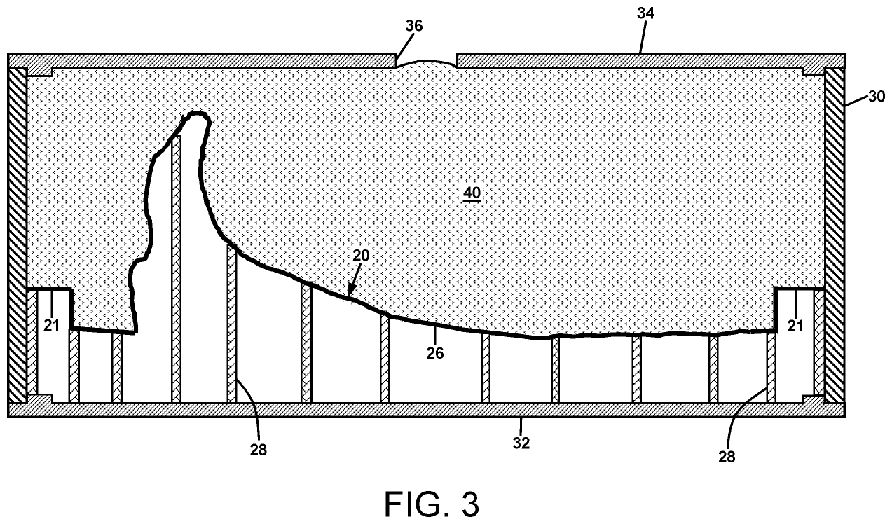

In step 140, a liquid or semi-solid mold block material is delivered into the molding fixture and cast against a first mold surface of the mold fixture, which is comprised of the region 22 corresponding to the external surface of the denture and the horizontal flange surface 24. Referring to FIG. 3, the mold block material 40 may be delivered through an opening 36 in a mold cover 34 that is fitted to the mold fixture 30. Alternatively, the mold block material 40 may be delivered into the mold fixture 30 through an open top thereof. The mold cover 34 may then be placed on the mold fixture 30. Any excess mold block material 40 can escape through the opening 36 in the mold block cover 34.

Following delivery of the mold block material 40 into the mold fixture 30, the mold block material 40 is cured to a solid or semi-solid state. In certain embodiments, the mold block material 40 may be a silicone material. In other embodiments, the mold block material 40 may be a reversible hydrocolloid impression material such as alginate. The hydrocolloid material, which may be delivered into the mold fixture in a heated state, solidifies into an elastic gel after cooling and cross linking.

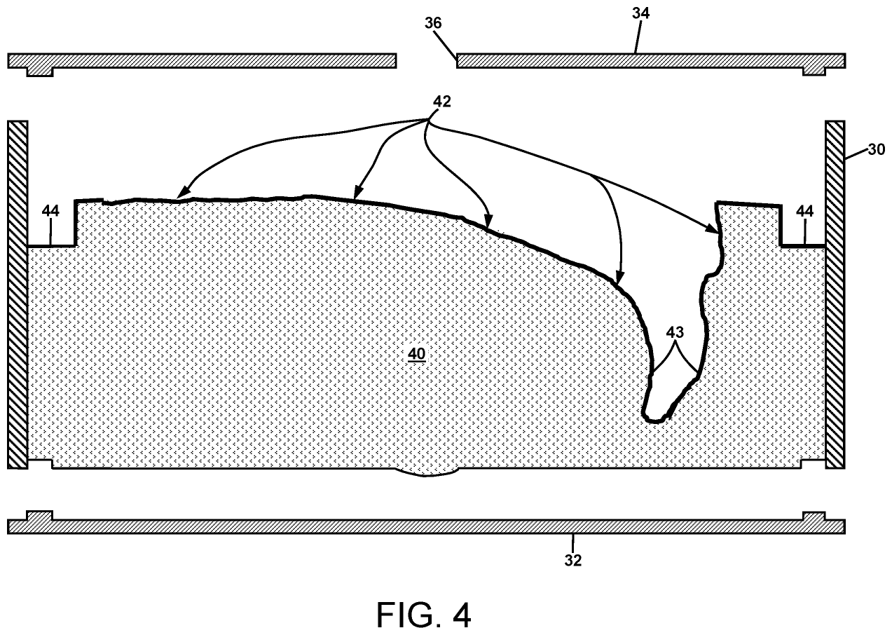

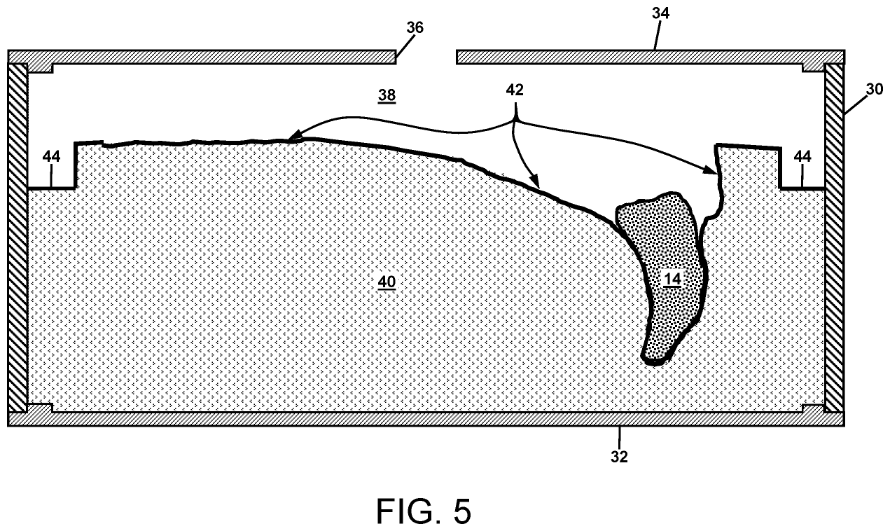

Referring to FIG. 4, after forming the mold block material 40 in the mold fixture 30, the covers 32 and 34 are removed from the mold fixture 30, the mold form 20 is removed from the mold fixture 30, and the mold fixture 30 is inverted so that the mold block material 40 is in the bottom of the mold fixture 30. The mold block material 40 includes a mold surface 42 with tooth sockets 43, and an annular flange surface 44. Referring to FIG. 5, in step 150, denture teeth 14 that were selected in the denture fabrication steps 110 are placed in the tooth sockets 43 of the mold block 40. The covers 32 and 34 are fitted to the mold fixture 30, forming a denture base cavity 38 therein.

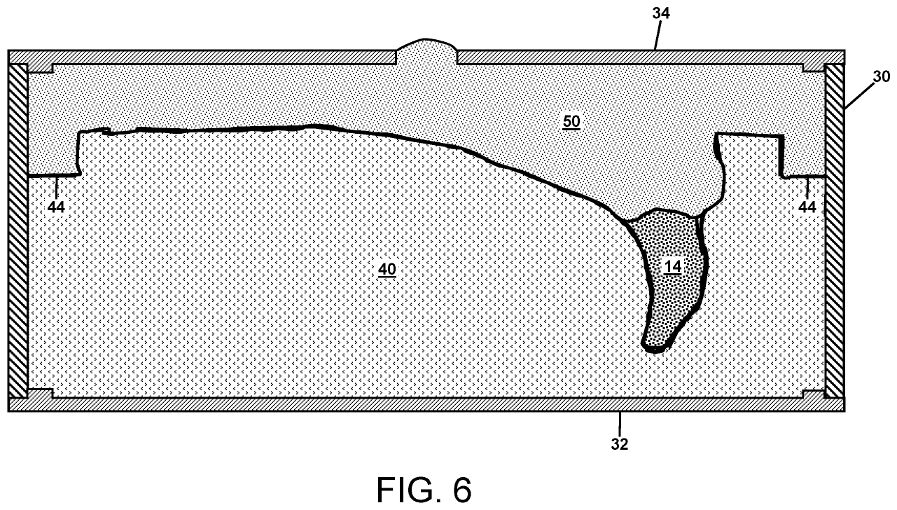

Referring to FIG. 6, in step 160, liquid denture base material is delivered into the denture base cavity and cast against the denture base surface portion 42 of the mold block material 40 and against bases of the denture teeth 14. In step 170, the liquid denture base material is crosslinked and cured into solid denture base block 50, within which are embedded the denture teeth 14. In certain embodiments, the denture base block 50 may be made of an auto-polymerizing material, such as polymethyl methacrylate. In certain embodiments, the molding fixture 30 may be placed in a pressure pot (not shown), and heat and pressure may be applied to accelerate the cross linking and solidification of the denture base block 50. The auto-polymerizing material of the denture base block 50 chemically bonds to the bases of the denture teeth 14, thereby forming a strong bond between the teeth 14 and the solid denture base material.

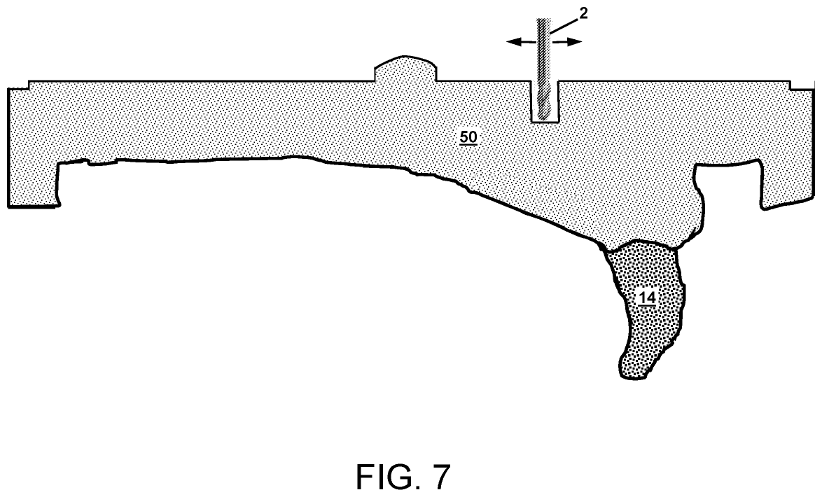

In step 180, the denture base block 50 with embedded denture teeth 14 is removed from the molding fixture 30. Referring to FIG. 7, the denture base block 50 in the form of a cylindrical disk is placed in a standard milling fixture (not shown) of a mill (not shown). The mill is preferably a computer numerically controlled (CNC) mill, in which the digital denture date obtained in steps 110 can be uploaded. In step 190, the mill rotates a milling bit 2 and articulates the bit 2 around multiple axes and along multiple pathways, and removes all of the material of the denture base block 50 except for the material of the denture base 12, thereby forming the intaglio (tissue) side, i.e., the internal surface 19 of the denture. During the milling step, any excess height of teeth 14 will also be automatically removed, i.e., an upper portion 15 of teeth 14 will be removed by the mill bit 2. Advantageously, the removal of the upper portion 15 of teeth 14 solves one of the main problems with conventional “digital dentures,” which is that the vertical height of the teeth 14 must be adjusted to conform to the available vertical space (VDO—vertical dimension of occlusion) in the mouth of the patient.

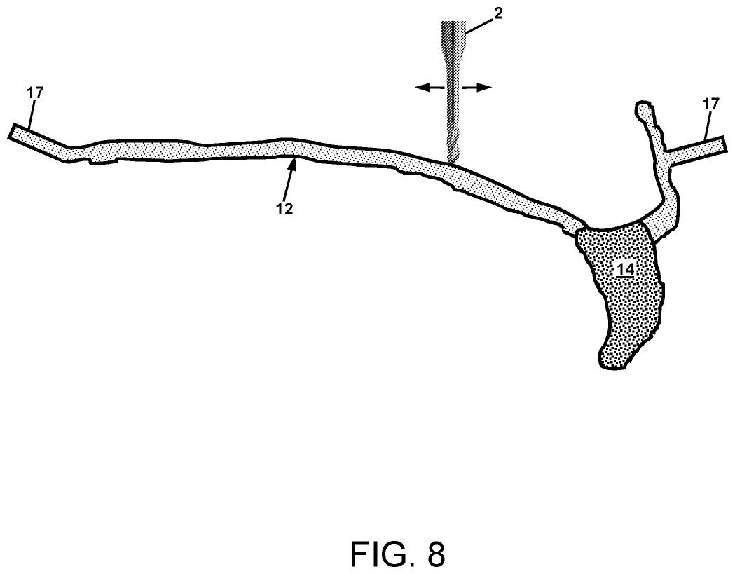

Referring to FIG. 8, it can be seen that most of the denture base block 50 and the upper portion 15 (FIG. 7) of the teeth 14 have been removed by the mill bit 2, and that only some support material 17 remains to be removed from the denture base 12 at the conclusion of the milling step 190. This material 17 may be removed using an abrasive cut-off disc or bur. The denture may then be polished using conventional pumice and polishing compounds. The resulting completed denture 10, as described previously, is shown in FIG. 9.

Referring again to FIG. 10, an alternative embodiment of the method may begin by performing the denture design steps 110. However, instead of performing step 120 to produce the mold form 40 as depicted in FIG. 3, the mold form 40 may be produced using an additive process such as 3D printing. Such a process may be performed using a Model Eden 260VS 3D printer, or a Model Dental Prime 3D printer manufactured and sold by Stratasys Ltd. of Edina MN. Such 3D printers are capable of printing elastic support materials. Making the mold form 40 from an elastic material is preferable so as to enable the placement of denture teeth 14 into the tooth sockets of the mold form 40. Following the fabrication of the mold form 40 by 3D printing, the method proceeds with steps 130-190 as described previously to produce the complete denture. Advantageously, it is anticipated that making the mold form 40 from an elastic support material will reduces denture fabrication time and cost. The elastic support material is less costly than the 3D printed plastic resin described previously.

It is therefore apparent that there has been provided, in accordance with the present disclosure, a method of making a denture. The foregoing description of technology and the invention is merely exemplary in nature of the subject matter, manufacture, and use of the invention and is not intended to limit the scope, application, or uses of any specific invention claimed in this application or in such other applications as may be filed claiming priority to this application, or patents issuing therefrom. The following definitions and non-limiting guidelines must be considered in reviewing the description.

The headings in this disclosure (such as “Background” and “Summary”) and sub-headings used herein are intended only for general organization of topics within the present technology, and are not intended to limit the disclosure of the present technology or any aspect thereof. In particular, subject matter disclosed in the “Background” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

To the extent that other references may contain similar information in the Background herein, said statements do not constitute an admission that those references are prior art or have any relevance to the patentability of the technology disclosed herein. Any discussion in the Background is intended merely to provide a general summary of assertions.

The description and specific examples, while indicating embodiments of the technology disclosed herein, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

Unless otherwise specified, relational terms used in the present disclosure should be construed to include certain tolerances that those skilled in the art would recognize as providing equivalent functionality. By way of example, the term perpendicular is not necessarily limited to 90.00°, but also to any variation thereof that those skilled in the art would recognize as providing equivalent functionality for the purposes described for the relevant member or element. Terms such as “about” and “substantially” in the context of configuration relate generally to disposition, location, and/or configuration that is either exact or sufficiently close to the location, disposition, or configuration of the relevant element to preserve operability of the element within the invention while not materially modifying the invention. Similarly, unless specifically specified or clear from its context, numerical values should be construed to include certain tolerances that those skilled in the art would recognize as having negligible importance, as such do not materially change the operability of the invention.

As referred to herein, all compositional percentages are by weight of the total composition, unless otherwise specified. As used herein, the words “comprise,” “include,” contain,” and variants thereof are intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present technology that do not contain those elements or features.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting ingredients, components or process steps, the Applicants specifically envision embodiments consisting of, or consisting essentially of, such ingredients, components or processes excluding additional ingredients, components or processes (for consisting of) and excluding additional ingredients, components or processes affecting the novel properties of the embodiment (for consisting essentially of), even though such additional ingredients, components or processes are not explicitly recited in this application. For example, recitation of a composition or process reciting elements A, B, and C specifically envisions embodiments consisting of, and consisting essentially of, A, B, and C, excluding an element D that may be recited in the art, even though element D is not explicitly described as being excluded herein.

Having thus described the basic concept of the invention, it will be apparent to those skilled in the art that the foregoing detailed disclosure is intended to be presented by way of example only, and is not limiting. Various alterations, improvements, and modifications will occur to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be expressly stated in the claims.

What is claimed is:

1. A method of making a denture comprised of a denture base and denture teeth, and having an external surface and an internal surface, the method comprising:
a) fabricating a mold form, including a first mold surface corresponding to the external surface of the denture;
b) casting a liquid mold block material against the first mold surface of the mold form, and curing the liquid mold block material into a solid or semi-sold state to form a mold block including a second mold surface corresponding to the external surface of the denture, the second mold surface including denture tooth sockets contiguous with a denture base surface portion;
c) placing denture teeth in the tooth sockets of the mold block;
d) delivering liquid denture base material against the denture base surface portion of the second mold surface and against bases of the denture teeth, and curing the liquid denture base material into a solid state to form a denture base block including embedded denture teeth; and
e) milling the denture base block to form the internal surface of the denture.

2. The method of claim 1, further comprising creating a three dimensional digital CAD model of the denture, which includes data defining the external surface of the denture usable to define the first mold surface of the mold form.

3. The method of claim 1, further comprising obtaining an impression of a patient's dentition, and using the impression to define the three dimensional digital CAD model of the denture.

4. The method of claim 1, wherein the mold form is made by milling mold form material from a mold form material starting block.

5. The method of claim 1, wherein the mold form is made by 3D printing.

6. The method of claim 1, wherein the mold form is bounded by a cylindrical perimeter and wherein the mold form is placed in a cylindrical mold fixture prior to casting the liquid mold block material.

7. The method of claim 1, wherein the mold form is comprised of an annular flange surrounding the first mold surface.

8. The method of claim 1, wherein following forming the mold block, the mold block is removed from a mold fixture, inverted, and replaced in the mold fixture.

9. The method of claim 1, wherein milling the denture base block includes removing upper portions of the embedded denture teeth.

10. The method of claim 1, further comprising removing support material from the denture base following the milling the denture base block.

11. A method of making a denture comprised of a denture base and denture teeth, and having an external surface and an internal surface, the method comprising:
a) creating a three dimensional digital CAD model of the denture, which includes data defining the external surface of the denture usable to define a first mold surface of a mold form;
b) fabricating the mold form, including a first mold surface corresponding to the external surface of the denture, by milling mold form material from a mold form material starting block;
c) casting a liquid mold block material against the first mold surface of the mold form, and curing the liquid mold block material into a solid or semi-sold state to form a mold block including a second mold surface corresponding to the external surface of the denture, the second mold surface including denture tooth sockets contiguous with a denture base surface portion;
d) placing denture teeth in the tooth sockets of the mold block;
e) delivering liquid denture base material against the denture base surface portion of the second mold surface and against bases of the denture teeth, and curing the liquid denture base material into a solid state to form a denture base block including embedded denture teeth; and
f) milling the denture base block to form the internal surface of the denture.

12. A method of making a denture comprised of a denture base and denture teeth, and having an external surface and an internal surface, the method comprising:
a) creating a three dimensional digital CAD model of the denture, which includes data defining the external surface of the denture usable to define a first mold surface of a mold form;
b) fabricating the mold form, including a first mold surface corresponding to the external surface of the denture, by 3D printing mold form material;
c) casting a liquid mold block material against the first mold surface of the mold form, and curing the liquid mold block material into a solid or semi-sold state to form a mold block including a second mold surface corresponding to the external surface of the denture, the second mold surface including denture tooth sockets contiguous with a denture base surface portion;
d) placing denture teeth in the tooth sockets of the mold block;
e) delivering liquid denture base material against the denture base surface portion of the second mold surface and against bases of the denture teeth, and curing the liquid denture base material into a solid state to form a denture base block including embedded denture teeth; and
f) milling the denture base block to form the internal surface of the denture.
